(19) United States
(12) Patent Application Publication
(10) Pub. No.: US 2014/0098398 A1
(43) Pub. Date: Apr. 10, 2014

(54) CLEAN AND COMPACT PRINTING

(71) Applicant: BUSINESS OBJECTS SOFTWARE LTD., Dublin (IE)

(72) Inventor: Godfrey Hobbs, Vancouver (CA)

(73) Assignee: Business Objects Software Ltd., Dublin (IE)

(21) Appl. No.: 13/648,977

(22) Filed: Oct. 10, 2012

(51) Int. Cl. G06K 15/02

(52) U.S. Cl. 358/1.15

(57) ABSTRACT

A document may contain summary information and detailed information, and the detailed information may be replaced with a set of printed machine-readable codes when the document is printed. As examples of such machine-readable codes, quick response codes (QR codes) may be used by a system to encode detailed information. For example, the system may access one or more tables of information as a list or file of comma-separated values (CSV), and the system may encode the one or more tables into corresponding QR codes. Each QR code hence may function as a “virtual” CSV file embedded in the printed report. A user may use a smart phone read the QR codes from the final printed report, and the smart phone may execute a software application that decodes and presents the detailed information to the user.

### TECHNICAL FIELD

The subject matter disclosed herein generally relates to the processing of data. Specifically, the present disclosure addresses systems and methods of printing a document.

### BACKGROUND

Data visualization and data driven reporting are often important to businesses. Both may be used in various ways. For a variety of reasons, business reports are often printed on paper before they are distributed or consumed. An example of a reason people may have for printing a business report is that paper is perceived in some situations as a medium for deep thought and analysis. People sometimes believe that paper allows them to think deeply, reflectively, and in a focused or intellectually autonomous manner. Another example of a reason people may have for printing the business report is that some studies have suggested that reading on a computer screen is 20-30% slower than reading paper. Such studies also suggest that comprehension is stronger when reading paper.

Report generation software (e.g., reporting tools) such as SAP Crystal Reports may be used to facilitate creation of pixel-perfect printed reports that appear on paper exactly as they appear on a computer screen. Like many software applications nowadays, printing with Crystal Reports exactly duplicates what is shown on the computer screen. The acronym “WYSIWYG” for “What You See is What You Get” describes this feature.

### BRIEF DESCRIPTION OF THE DRAWINGS

Some embodiments are illustrated by way of example and not limitation in the figures of the accompanying drawings.

FIG. 1 is a network diagram illustrating a network environment suitable for printing a document, according to some example embodiments.

FIG. 2 is a block diagram illustrating components of a document machine suitable for printing a document, according to some example embodiments.

FIG. 3 is a block diagram illustrating components of a device suitable for printing a document, according to some example embodiments.

FIG. 4-5 are block diagrams illustrating a document to be printed, according to some example embodiments.

FIG. 6-7 are block diagrams illustrating a version of the document to be printed, according to some example embodiments.

FIG. 8-10 are flowcharts illustrating operations of the document machine or the device in performing a method of printing a document, according to some example embodiments.

FIG. 11 is a block diagram illustrating components of a machine, according to some example embodiments, able to read instructions from a machine-readable medium and perform any one or more of the methodologies discussed herein.

### DETAILED DESCRIPTION

Example methods and systems are directed to printing of documents (e.g., reports). Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

In many situations, documents such as reports (e.g., business reports) may contain at least two types of information: “summary information” and “detailed information.” Examples of summary information include an abstract, a summary, a histogram, a pie chart, a line chart, a cross tabulation (e.g., a pivot table), or any suitable combination thereof. Summary information may allow a viewer to see broad or general concepts (e.g., the “Big Picture”) represented by detailed information. Detailed information is generally composed of raw data (e.g., raw tabular data), which may be presented in a report by directly adding a table (e.g., “dumping” a database table) onto one or more pages of the report. Detailed information may allow the viewer to narrow her focus to (e.g., “drill down” on) individual line items within the raw data. Accordingly, summary information (e.g., summary data may be viewed as being compact in the sense that it often only takes up a fraction of the final printed report. In contrast, detailed information (e.g., detailed data) may be voluminous and take up many pages (e.g., page upon page) in the final printed report. Hence, as used herein, “summary information” refers to a summarization of “detailed information,” where the detailed information would use up more space within a printed report than the summary information. In some situations, a document may include metadata (e.g., hidden information or markup tags) to identify or indicate which portions of the document contain summary information and which portions of the document contain detailed information.

The systems and methods described herein are configured to facilitate the printing of documents (e.g., reports) by use of a “compaction” operation into a printing process. The compaction step involves replacing detailed information with a set of one or more compact printed codes that are readable by a machine (e.g., machine-readable) but not necessarily readable by a person (e.g., human-readable). Examples of a machine-readable printed code is a one-dimensional barcode or a two-dimensional quick response code (QR code, also known as a quick read code). The summary information may then be printed (e.g., in its original form, “as is”). This may have the effect of allowing a report to be printed on fewer pages. For example, a document may be printed containing only summary information and one or more compact machine-readable codes that may be decoded to reproduce the detailed information summarized by the summary information. In particular, large documents with lots of detailed information may be compacted dramatically by the systems and methods discussed herein. Moreover, compaction of detailed information may be performed in a lossless manner (e.g., occurring without any loss of the compacted detailed information) so that the detailed information, when reproduced from the set of machine-readable codes, is the same as in the original document.

in some situations, a machine-readable code (e.g., a OR code) may be used to encode a uniform resource locator (URL) that links to a particular resource, such as a promotional website. However, using URLs to link from a printed document to corporate resources that contain detailed information from a business support may involve the viewer being online (e.g., connected to the Internet) and having network access to the corporate resource (e.g., a webserver). Today's business user may often be impeded from operating online due to data congestion, data roaming fees, having her mobile device disconnected from any network (e.g., in “airplane mode”), or any suitable combination thereof.

Moreover, today's business documents often contain sensitive or confidential information that should not be exposed via URL. One or more security risks may be encountered when exposing sensitive or confidential information as a URL. One or more security failures could lead to the exposure of this sensitive or confidential information. Therefore, it may be helpful to print detailed information in a manner that does not involve exposing linked resources. According to systems and methods described herein, a printed report with detailed information that has been compacted (e.g., replaced with a set of printed machine-readable codes) is generally self-contained. As examples of machine-readable codes, QR codes may be used by a system (e.g., a machine that forms all or part of a printing system or a document generation system) to encode detailed information (e.g., in tabular form). For example, the system may access one or more tables of information as a list or file of comma-separated values (CSV), and the system may encode the one or more tables into corresponding QR codes. Each QR code hence may function as a “virtual” CSV file embedded in the final printed report. A user may then use a smart phone to read the QR code from the final printed report, and the smart phone (e.g., using a custom software application) may decode and present the detailed information to the user.

For enhanced security, the “virtual” CSV file may be encrypted by the system such that it could then be decrypted only by a custom smartphone application. In some situations, encryption may consume a significant part of the information space on a QR code, thereby reducing the amount of detailed data stored in each QR code. In such situations, the system may account for encryption overhead in calculating how much detailed information to compact into a particular QR code. In addition, a smart phone application for reading, decoding, and presenting detailed information encoded as QR codes may be secured via various security measures (e.g., strong passwords or two-factor authentication). Such encryption measures may protect the data encoded in the QR code in the event an attacker obtains the physical printed report.

Consider the following hypothetical scenario for clean and compact printing of an end-of-quarter sales report. Suppose Alex is a regional sales lead who typically prepares for the end-of-quarter by asking Bob to prepare his reports. At the finish of each quarter, Alex takes a five-hour flight to his company's corporate headquarters to discuss the end-of-quarter with his management and peers. Suppose Bob is a data analyst who regularly creates various reports for Alex. Alex has a strong preference for printed reports. Alex feels that paper allows him to be effective so that he can really focus on the end-of-quarter reports. He experiences a “flow” when working with paper and pen that for him is otherwise not possible. Alex often makes annotations on each page of the printed report. Once Alex completes his review, he sits down with management and colleagues to go over these annotations.

However, suppose that, last quarter, the summary reports that provided only summary information were not sufficient for Alex, who discovered that he really does need the detailed information as part of his end-of-quarter review. Accordingly, Alex asked Bob to include this detailed information in this quarter's printouts. Bob wants to help Alex with this request, but when Bob performed a “print preview,” he noticed that each report was now over 20 pages long. Adding the detailed information made the reports balloon in size. Alex and Bob agree that over 20 pages for each report is far too long. As a result, Bob decides to try using a “compact printing” feature implemented in his report generation software. Bob clicks the “compact print” button, which causes each printed report to be reduced from over 20 pages to only three pages.

Bob notices QR codes appearing on the printout. In response, Bob tries scanning the QR codes with his smart phone. The smart phone's camera scans a QR code and prompts Bob to install a CSV viewing application. Bob finds a free application on the Internet and installs it. Now Bob's smart, phone is able to scan the QR code and view present (e.g., display) the detailed information encoded in the QR code. Bob shows Alex how this feature works. Alex is now able to quickly scan and view the detailed data with his mobile device (e.g., an Apple iPad).

Alex hates to waste those five long hours of flight time. Alex likes the feature but is worried about being disconnected from the Internet (e.g., due to putting his mobile device into “airplane mode”) during his flight and not being able to retrieve any information to which the QR codes may link. Alex and Bob decide to run a test. Alex puts his mobile device (e.g., an Apple iPad) into “airplane mode” and tries to scan one of the QR codes. It works exactly as before, and Alex can view the detailed information on his mobile device, even though the device is disconnected from any network. As a result, Alex is really happy. He can still use the paper report to see the big picture. He can continue to make notes and highlight parts of each primed report. Now, when Alex wants to see detailed information, he can use his mobile device to scan and present the detailed information.

Systems and methods described herein facilitate compact printing of reports via machine-readable codes (e.g., QR codes). According to various example embodiments, a “report” may be a document that includes information automatically retrieved from a data source where the information is structured in accordance with a report schema. The schema may specify the form in which the information should be presented, including how it should be sorted, how it should be grouped (e.g., how sections are formed), how it may be further filtered, how values contained therein may be calculated, and other rules for processing the information contained in the report.

A machine-readable code may be used to encode a report's detailed data (e.g., in tabular form). As noted above, an example of a machine-readable code is a barcode (e.g., a one-dimensional barcode). Another example of a machine-readable code is a QR code (e.g., a two-dimensional barcode). The systems and methods may involve exporting detailed data from the reports into a CSV format, applying one or more object models or definitions to the report (e.g., grouping, report modification, pagination, or truncation), encryption of data (e.g., the detailed data, the machine-readable code, or both), and compression of data (e.g., column-based data compression). Certain example embodiments of the systems and methods are configured to reduce a likelihood that a single row of tabular detailed data will be broken up into two or more separate machine-readable codes. That is, the partitioning of the detailed data may respect row boundaries without resulting in duplication of data or wasted capacity in the machine-readable codes. The systems and methods may take into account an increase in the size of the detailed data, as measured in bytes or characters, due to encryption, encoding, or both.

In some example embodiments, a system (e.g., one or more machines that form all or part of the system) may be configured (e.g., by one or more modules) to operate as follows. The user clicks on a “print” or “export” button within a graphical user interface of a report viewer application or a report generator application (e.g., executing on the system). If a “compact print” option is not selected, the report prints in its entirety (e.g., including all of its detailed information). If the “compact print” option is selected, the system checks a report object model (e.g., a data structure that defines summary information and detailed information) and determines whether the report has any detailed information. If the report has no detailed information (e.g., no sections for detailed information), the report is printed in full. However, if the report has any sections of detailed information, then the system exports those sections of detailed information into CSV formatted data. If an “encrypt compact code” option is selected, the system obtains a suitable combination of encryption keys, encryption salts, and encryption algorithms (e.g., from a database).

The system then determines a chunk size for a first chunk (e.g., “chunk 1”) of the CSV formatted data, based on a predetermined capacity for a chunk (e.g., 2048 characters). According to some example embodiments, the system selects only complete rows of the CSV formatted data for encoding into the first chunk. For example, the first row of the CSV formatted data may be selected for the first chunk. In some example embodiments, if any single row is greater than the chunk size, then the printing is aborted, and the system will attempt to show the user an appropriate error message. If encryption is enabled, the system encrypts the CSV formatted data that is selected for inclusion in the first chunk. In certain example embodiments, the system performs encryption, as well as Base64 encoding, before storing the results as an encrypted version of the first chart (e.g., “chunk 1 encrypted”). In some situations, the size of the encrypted first chunk is larger than the non-encrypted first chunk. If the encrypted first chunk is too big to be correctly encoded (e.g., bigger than the chunk size), then the system may discard the first chunk, the encrypted first chunk, or both, and reattempt to encode the first chunk using a smaller chunk size. For example, the system may iteratively reduce the chunk size and reattempt the encoding of the first chunk until the size of the encrypted first chunk is less than, the chunk size. The system may then encode the first chunk into a machine-readable code (e.g., a QR code).

The machine-readable code (or an image thereof) may be stored by the system (e.g., in a database, and cache, or both) and marked as a completed code (or image thereof) that corresponds to the report. The system may also generate an authentication code for the stored machine-readable code (or its stored image). For example, the system may generate a hash-based message authentication code (HMAC) of the data contained in the machine-readable code, and the system may key this HMAC to the stored machine-readable code (or its image).

This process may be repeated for subsequent chunks of the CSV formatted data exported from a section of the detailed information in the report, until the size of the next chunk is zero. Moreover, this process may be used for each of multiple sections of detailed information in the report. Accordingly, the system may use this iterative process to generate a complete set of machine-readable codes (e.g., QR codes) for the one or more sections of detailed information within the report. Moreover, this set of machine-readable codes may be stored (e.g., cached) for use in printing a compact version of the full report. The system may then use this set of machine-readable codes to replace the sections of detailed information in the report. With the sections of detailed information replaced by the set of machine-readable codes, the report may be considered as a “compacted” report. This compacted report may be printed on paper or exported to a file and stored as a new instance of the report. When printed, the compacted report shows its summary information and the set of machine-readable codes, but not the detailed information that has been replaced with the set of machine-readable codes.

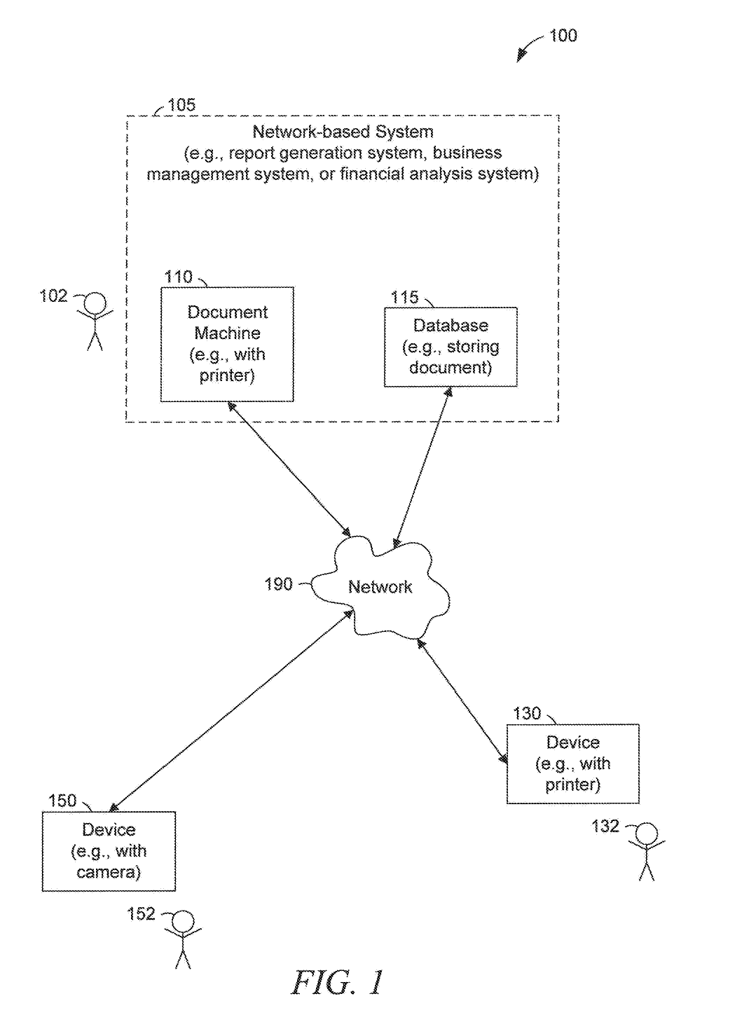

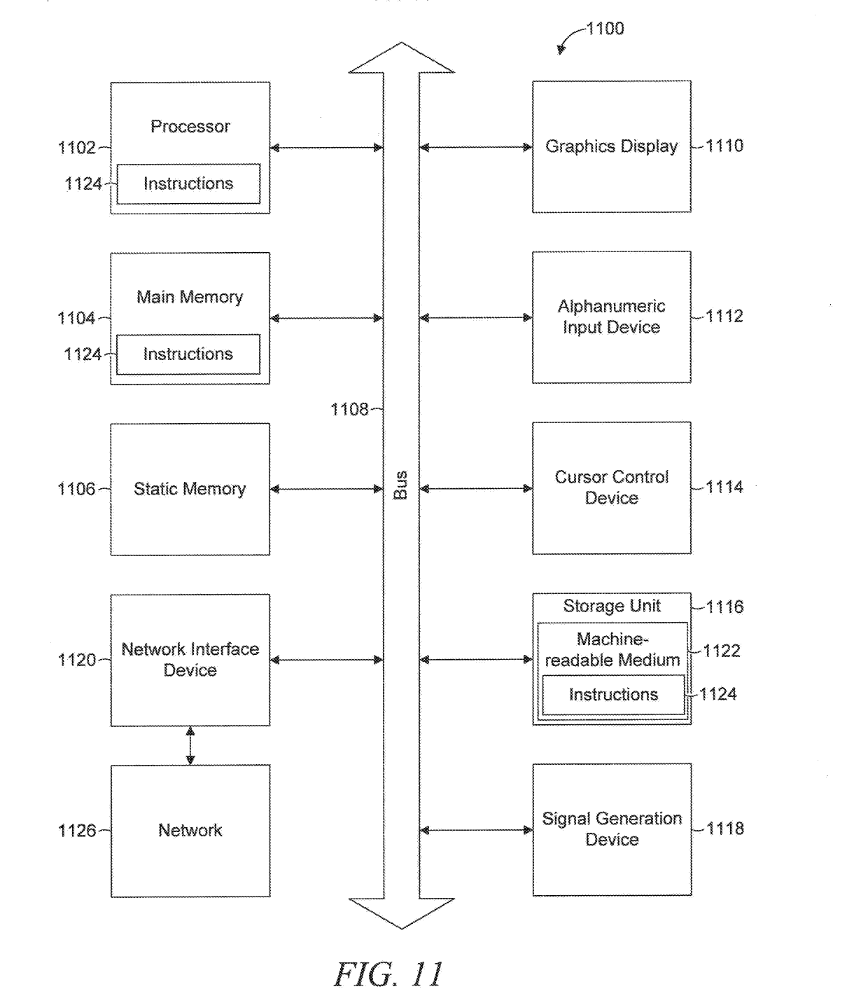

FIG. 1 is a network diagram illustrating a network environment suitable for printing a document, according to some example embodiments. The network environment 100 includes a document machine 110, a database 115, and devices 130 and 150, all communicatively coupled to each other via a network 190. The document machine 110 and the devices 130 and 150 may each be implemented in a computer system, in whole or in part, as described below with respect to FIG. 11.

The document machine 110 may be connected to a printer (e.g., a printer device, such as an inkjet printer or a laser printer) or include a built-in printer. In some example embodiments, the document machine 110 is a server machine that provides one or more document-related services (e.g., a cloud-based document generation service). The database 115 may store one or more documents (e.g., business reports) to be printed. For example, the database 115 may store documents generated by the document machine 110, documents generated by the device 130, or both. The document machine 110, the database 115, or both, may form all or part of a network-based system 105. For example, the network-based system 105 may be or include a report generation system, a business management system, a financial analysis system, or any suitable combination thereof.

The device 130 may be connected to a primer (e.g., a printer device, such as an inkjet printer or a laser printer) or include a built-in printer. The device 150 may be connected to a camera (e.g., a still camera, video camera, or other optical imaging device) or include a built-in camera. Using some or all of the methodologies discussed herein, the document machine 110 or the device 130 may access a document (e.g., from its own memory, or from the database 115), compact the document by generating one or more machine-readable codes from which the document's sections of detailed information are reproducible for viewing (e.g., losslessly), and provide (e.g., print or communicate) a version of the document that replaces the sections of detailed information with the generated codes.

Also shown in FIG. 1 are users 132 and 152. One or both of the users 132 and 152 may be a human user (e.g., a human being), a machine user (e.g., a computer configured by a software program to interact with the device 130), or any suitable combination thereof (e.g., a human assisted by a machine or a machine supervised by a human). The user 132 is not part of the network environment 100, but is associated with the device 130 and may be a user of the device 130. For example, the device 130 may be a desktop computer, a vehicle computer, a tablet computer, a navigational device, a portable media device, or a smart phone belonging to the user 132. Likewise, the user 152 is not part of the network environment 100, but is associated with the device 150. As an example, the device 150 may be a desktop computer, a vehicle computer, a tablet computer, a navigational device, a portable media device, or a smart phone belonging to the user 152.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 11. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the document machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

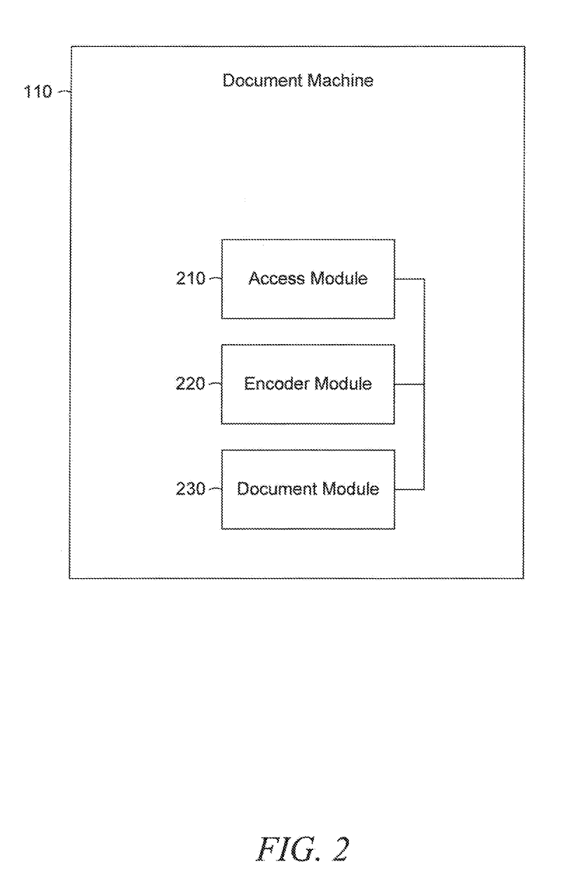

FIG. 2 is a block diagram illustrating components of the document machine 110, according to some example embodiments. The document machine 110 includes an access module 210, an encoder module 220, and a document module 230, all configured to communicate with each other (e.g., via a bus, shared memory, or a switch). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules.

The access module 210 is configured to access a document (e.g., from the database 115 or from a memory of the document machine 110). The document may include (e.g., contain) a summary section (e.g., a “first section”) and a detailed section (e.g., a “second section”). The detailed section may be a portion of the document that contains detailed information (e.g., tabular rows of data formatted as CSVs), and the summary section may be another portion of the document that summarizes the detailed information contained in the detailed section. Furthermore, the document may include metadata that defines (e.g., indicates, identifies, or marks) the summary section and the detailed section. In some example embodiments, the document includes multiple summary sections for multiple detailed sections, and the document's metadata defines those multiple summary sections and multiple detailed sections.

The encoder module 220 is configured to generate one or more machine-readable codes that correspond to the detailed section of the document accessed by the access module 210. The machine-readable codes encode the detailed information contained in the detailed section of the document, and the machine-readable codes will eventually replace the detailed section in the printed version of the document. Accordingly, each of the one or more machine-readable codes corresponds to at least a portion of the detailed section of the document. In other words, where multiple machine-readable codes are used to represent the entirety of the detailed information in the detailed section of the document, each machine-readable code is a machine-readable code from which a portion of the detailed section is reproducible for viewing. The encoder module 220 may therefore generate a machine-readable code based on (e.g., from) a portion of the detailed section of the document.

The document module 230 is configured to provide a version of the document (e.g., by printing, communicating, or displaying the version of the document). The version of the document may include the summary section of the document, and the version may replace the detailed section with the machine-readable codes generated by the encoder module 220. Where multiple machine-readable codes are generated to represent the entirety of the detailed information in the detailed section of the document, the version of the document provided by the document module 230 replaces a portion of the detailed section with its corresponding machine-readable code, as generated by the encoder module 220.

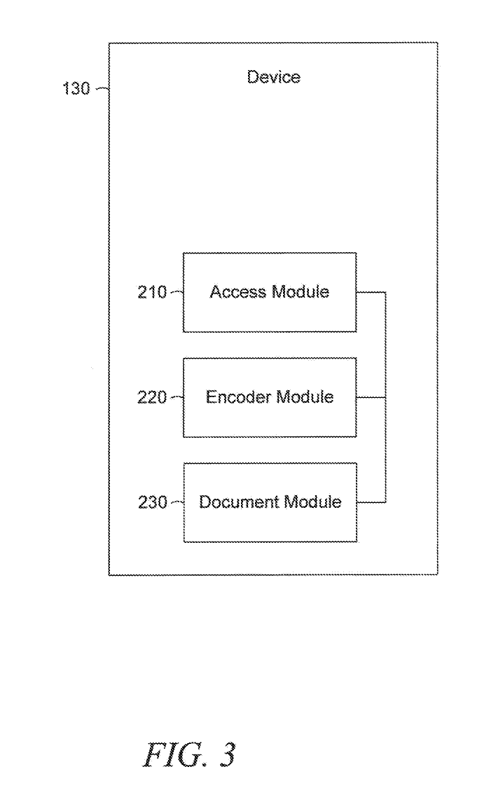

FIG. 3 is a block diagram illustrating components of the device 130, according to some example embodiments. The device 130 may include the access module 210, the encoder module 220, and the document module 230, all configured to communicate with each other (e.g., via a bus, shared memory, or a switch). As noted above, any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules.

As noted above, the access module 210 may be configured to access a document from the database 115 or from a memory of the device 130). The encoder module 220 may be configured to generate one or more machine-readable codes that correspond to the detailed section of the document accessed by the access module 210. As noted above, where multiple machine-readable codes are used to represent the entirety of the detailed information in the detailed section of the document, each machine-readable code may be a machine-readable code from which a portion of the detailed section is reproducible for viewing. The encoder module 220 may therefore generate a machine-readable code based on (e.g., from) a portion of the detailed section of the document. As also noted above, the document module 230 may be configured to provide a version of the document (e.g., by printing, communicating, or displaying the version of the document). The version of the document may include the summary section of the document, and the version may replace the detailed section with the machine-readable codes generated by the encoder module 220. Where multiple machine-readable codes are generated to represent the entirety of the detailed information in the detailed section of the document, the version of the document may replace a portion of the detailed section with its corresponding machine-readable code.

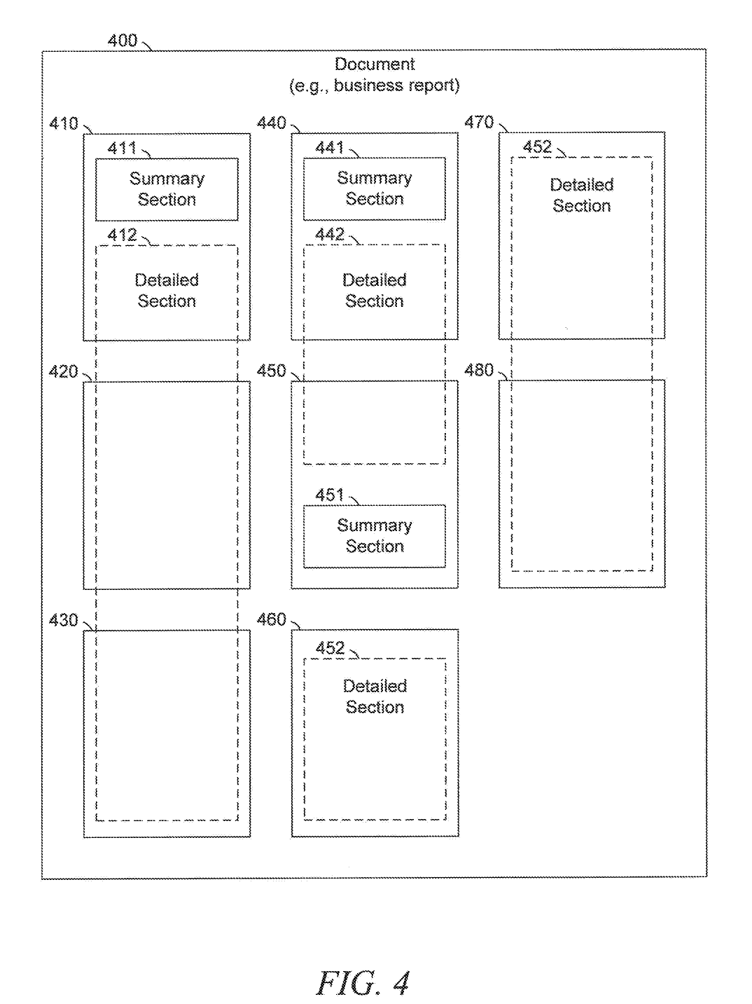

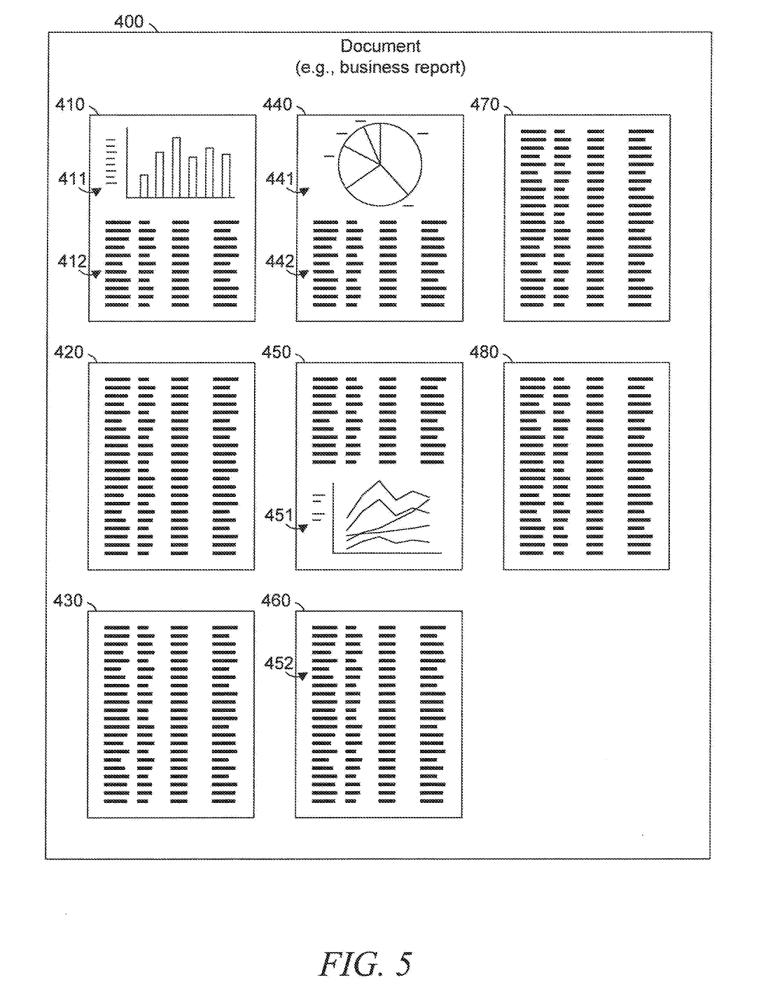

FIG. 4-5 are block diagrams illustrating a document 400 to be printed, according to some example embodiments. As shown, the document 400 may be a report (e.g., business report) and may include multiple pages 410, 420, 430, 440, 450, 460, 470, and 480, which may be sequential pages within the document 400 (e.g., pages that are numbered 1 through 8). The document 400 may include multiple sections of summary information. In the example shown in FIG. 4, the document 400 includes multiple summary sections 411, 441, and 451. The document 400 may also include multiple sections of detailed information. In the example shown in FIG. 4, the document 400 includes multiple detailed sections 412, 442, and 452. The summary section 411 may correspond to the detailed section 412 and summarize the detailed section 412. Similarly, the summary section 441 may correspond to the detailed section 442 and may summarize the detailed section 442. Likewise, the summary section 451 may correspond to the detailed section 452 and may summarize the detailed section 452.

According to various example embodiments, a summary section (e.g., summary section 411) may summarize its corresponding detailed section (e.g., detailed section 412) in one or more parts. As an example, the summary section 411 may be a single graph that summarizes the detailed section 112. As another example, the summary section 411 ma take the form of multiple graphs to summarize the detailed section 112. As a further example, the summary section 411 may be split into subsections, where a first subsection (e.g., an executive summary) provides a short summary of the detailed section 112, while a second subsection (e.g., an analytical summary) provides a longer summary of the detailed section 112. As yet another example, the summary section 411 may include a graphical subsection (e.g., a graph) in combination with a textual subsection (e.g., a sentence, paragraph, or table).

As shown in FIG. 4, the summary section 411 is included (e.g., contained) in the page 410 of the document 400, and its corresponding detailed section 412 spans the pages 410, 420, and 430. In FIG. 5, the summary section 411 appears on the page 410 as a bar graph (e.g., bar chart) that summarizes the detailed section 412, which is represented in FIG. 5 on the pages 410-430 as tabular rows of detailed information (e.g., rows of tabular data formatted as CSVs).

As shown in FIG. 4, the summary section 441 is included in the page 440, and its corresponding detailed section 442 spans the pages 440 and 450. In FIG. 5, the summary section 441 appears on the page 440 as a pie graph (e.g., pie chart) that summarizes the detailed section 442, which is represented in FIG. 5 on the pages 440 and 450 as tabular rows of detailed information.

As shown in FIG. 4, the summary section 451 is included in the page 450, while its corresponding detailed section 452 spans the pages 460, 470, and 480. In FIG. 5, the summary section 451 appears on the page 450 as a line graph (e.g., line chart) that summarizes the detailed section 452, which is represented in FIG. 5 on the pages 460-480 as tabular rows of detailed information.

According to various example embodiments, the document 400 is generated to include the multiple pages 410-480. For example, the document 400 may be a multi-page report (e.g., business report) generated by a report generation system, a business management system, a financial analysis system, or any suitable combination thereof. Accordingly, printing the document 400 may involve printing all of the multiple pages 410, 420, 430, 440, 450, 460, 470, and 480.

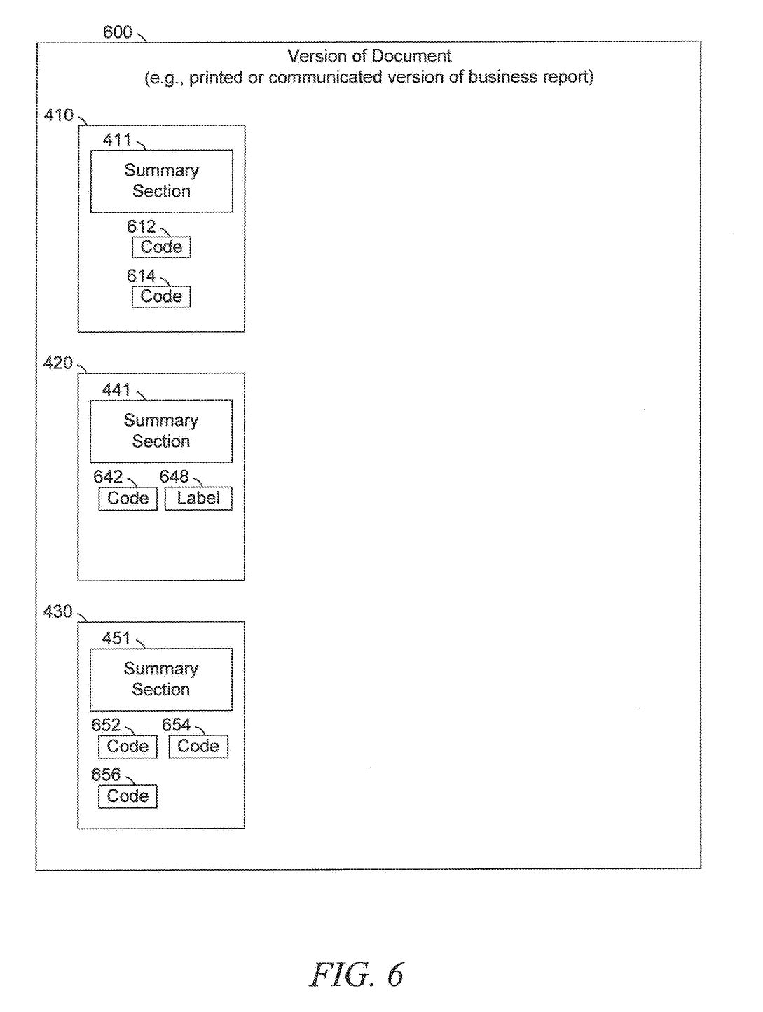

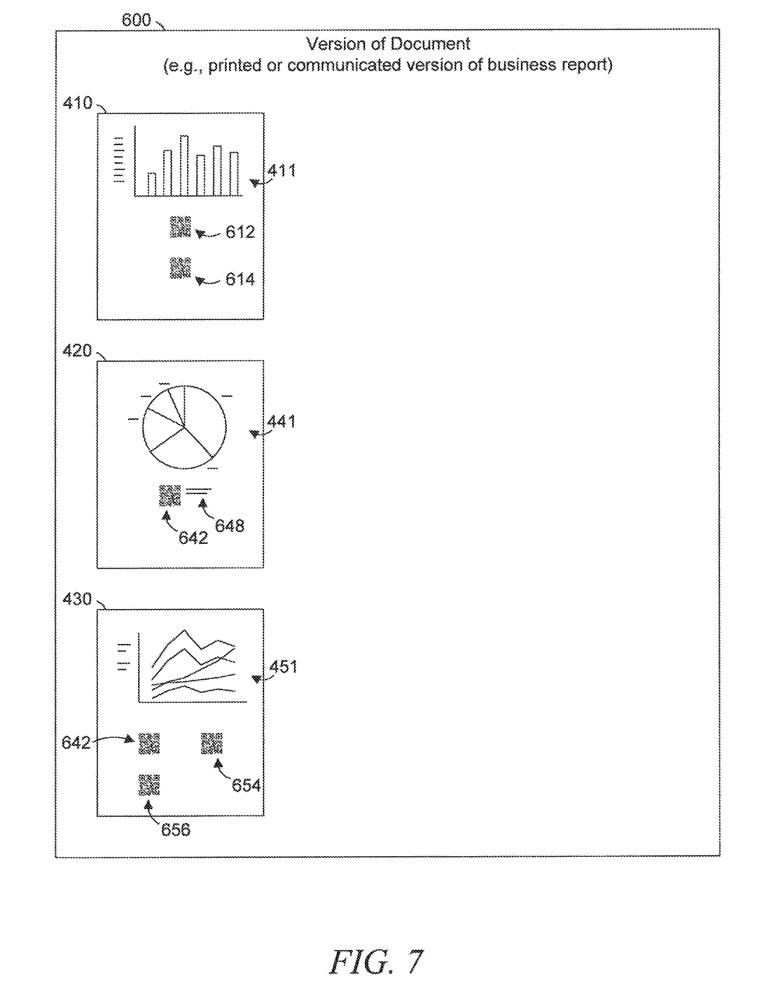

FIG. 6-7 are block diagrams illustrating a compacted version 600 of the document 400 to be printed, according to some example embodiments. As shown, the version 600 may be a compacted (e.g., shortened or abbreviated) version of the document 400 discussed above with respect to FIG. 4-5. The version 600 may include the multiple pages 410, 420, and 430, which may be fewer in number than the multiple pages 410, 420, 430, 440, 450, 460, 470, and 480 in the document 400 in its original form, as described above with respect to FIG. 4-5.

The version 600 may include, the sections of summary information that appear in the document 400. In the example shown in FIG. 6, the version 600 includes the multiple summary sections 411, 441, and 451. The version 600 may lack the detailed sections 412, 442, and 452 that appear in the document 400 in its original form. Instead, the version 600 may include codes 612, 614, 642, 652, 654, and 656 (e.g., machine-readable codes), which may replace the detailed sections 412, 442, and 452 within the version 600.

As shown in FIG. 6, the summary section 412 may correspond to the codes 612 and 614, and the codes 612 and 614 may encode the detailed information from the detailed section 412. For example, the code 612 may encode a portion of the detailed section 412 (e.g., a portion of the detailed information from the detailed section 412), while the code 614 may encode the remainder of the detailed section 412 (e.g., the remainder of the detailed information from the detailed section 412). In FIG. 7, the summary section 411 appears on the page 410 as a bar graph that corresponds to the codes 612 and 614, which are represented in FIG. 7 as a pair of two-dimensional barcodes (e.g., QR codes). As shown in FIGS. 4 and 6, the detailed section 412 may span more pages in the document 400 than the codes 612 and 614 within the version 600 of the document 400.

As shown in FIG. 6, the summary section 441 may correspond to the code 642, and the code 642 may encode the detailed information from the detailed section 442. In some example embodiments, a label 648 may be included in the version 600 (e.g., adjacent or proximate to the code 642, or otherwise on the same page 420 as the code 642) to describe the detailed information that is reproducible from the code 642 (e.g., by decoding the code 642). The code 642 may encode the entirety of the detailed section 442 (e.g., all of the detailed information included in the detailed section 442). In FIG. 7, the summary section 441 appears on the page 420 as a pie graph that corresponds to the code 642, which is represented in FIG. 7 as a solitary two-dimensional barcode (e.g., QR code). The label 648 appears in FIG. 7 as lines of text that appear next to the two-dimensional barcode. As shown in FIGS. 4 and 6, the detailed section 442 may span more pages in the document 400 than the code 642 within the version 600 of the document 400.

As shown in FIG. 6, the summary section 451 may correspond to the codes 652, 654, and 656, and the codes 652, 654, and 656 may encode the detailed information from the detailed section 452. For example, the code 652 may encode a first portion of the detailed section 452 (e.g., a first portion of the detailed information from the detailed section 452); the code 654 may encode a second portion of the detailed section 452 (e.g., a second portion of the detailed information from the detailed section 452); and the code 656 may encode a third portion of the detailed section 452 (e.g., the rest of the detailed information from the detailed section 452). In FIG. 7, the summary section 451 appears on the page 430 as a line graph that corresponds to the codes 652, 654, and 656, which are represented in FIG. 7 as a trio of two-dimensional barcodes. As shown in FIGS. 4 and 6, the detailed section 452 may span more pages in the document 400 than the codes 652, 654, and 656 within the version 600 of the document 400.

According to various example embodiments, the version 600 of the document 400 is a printed or communicated version of the document 400, and the version 600 may include fewer pages (e.g., pages 410, 420, and 430) than the document 400. Accordingly, printing the version 600 may involve printing only the pages 410, 400, and 430, instead of the larger number of pages (e.g., pages 410-480) in the document 400 in its original form, as described above with respect to FIG. 4-5.

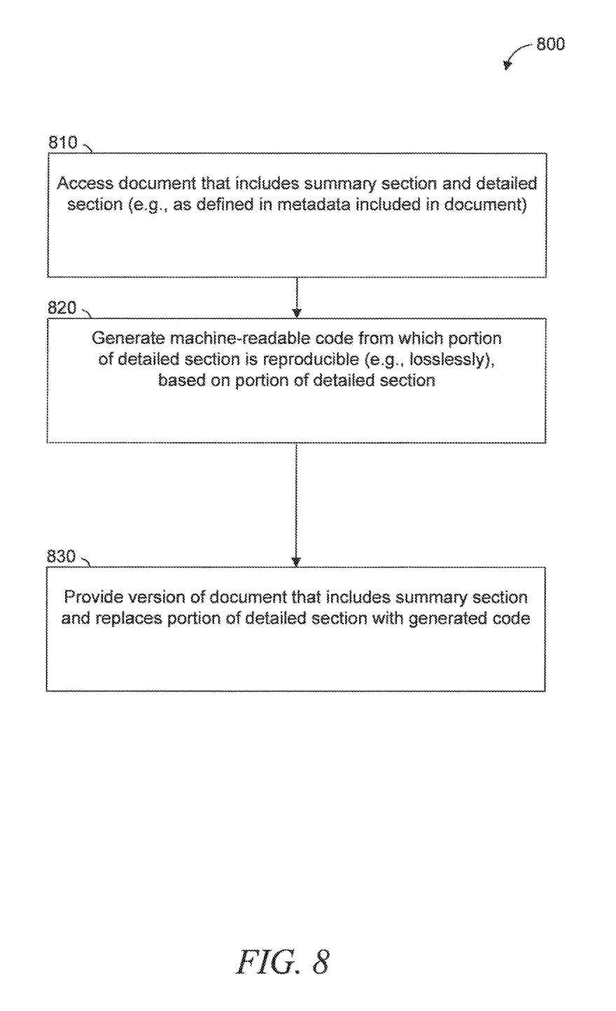

FIG. 8-10 are flowcharts illustrating operations of the document machine 110 or the device 130 in performing a method 800 of printing the document 400, according to some example embodiments. Operations in the method 800 may be performed using modules described above with respect to FIG. 2-3. As shown in FIG. 8, the method 800 includes operations 810, 820, and 830.

In operation 810, the access module 210 accesses the document 400 (e.g., from the database 115). As noted above, the document 400 may include a summary section (e.g., summary section 411, which may be called, a “first” section) that summarizes a corresponding detailed section (e.g., detailed section 412, which may be called a “second” section), and the document 400 may include metadata markup tags) that defines the summary section and the detailed section. Moreover, the access module 210 may access the document. 400 in response to a request for provision of the document 400 (e.g., a command or request to provide the document 400 by printing or communicating the document 400). According to various example embodiments, such a request may be received by the access module 210 (e.g., from a user interface of document generation software, document editing software, report generation software, business manager software, financial analysis software, or any suitable combination thereof).

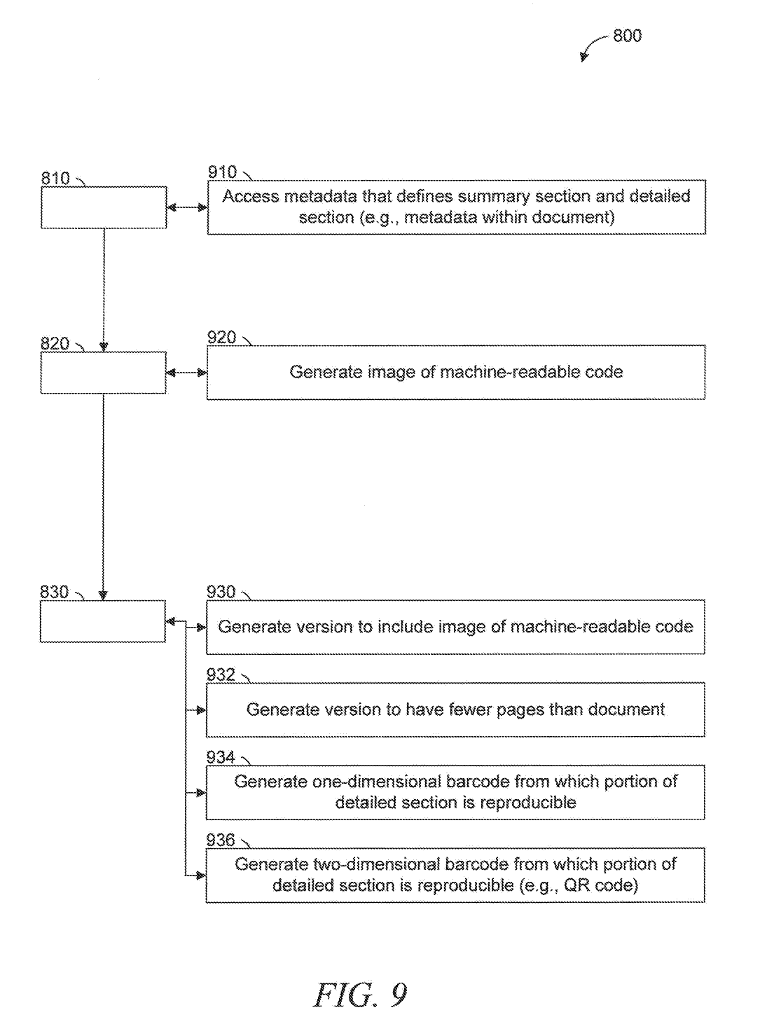

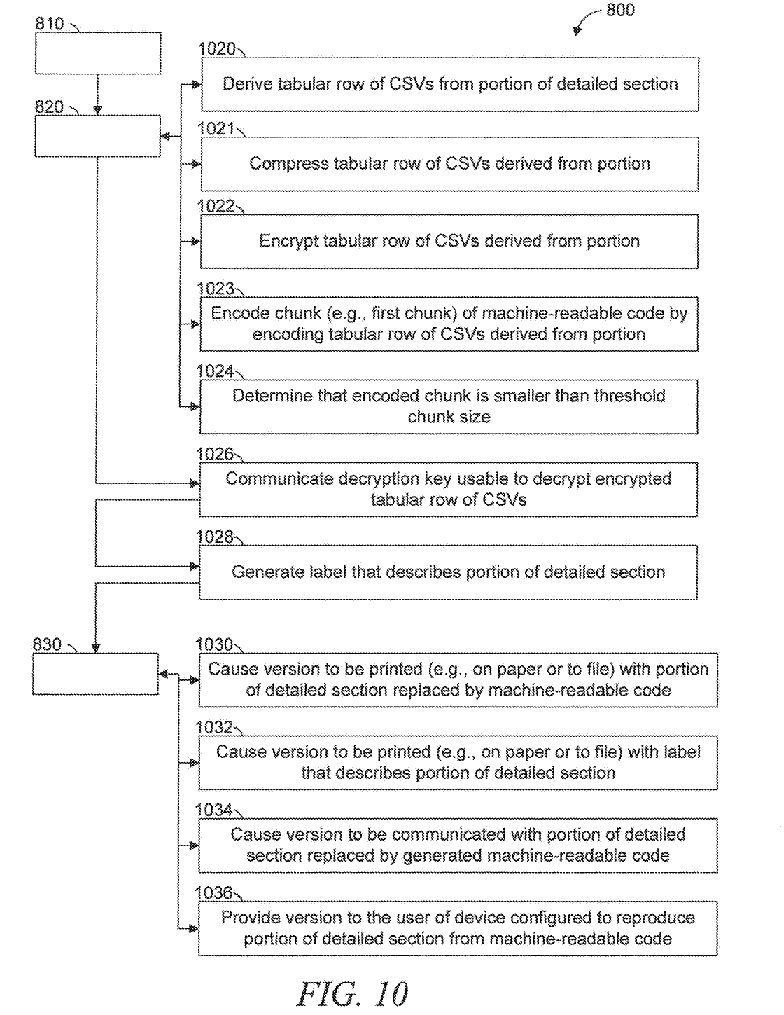

In operation 820, the encoder module 220 generates a machine-readable code (e.g., code 612) that corresponds to the detailed section (e.g., detailed section 412) discussed above with respect to operation 810. The encoder module 220 may generate the code based on the detailed section or based on a portion thereof. For example, the encoder module 220 may generate the code 612 based on a first portion of the detailed section 412, and the first portion of the detailed section 412 may be reproducible (e.g., for viewing) from the generated code 612. As another example, the encoder module 220 may generate the code 642 based on the entirety of the detailed section 442, and the entirety of the detailed section 442 may be reproducible (e.g., for viewing) from the generated code 642. Moreover, generation of the machine-readable code may be lossless (e.g., occurring without loss of any detailed information included in the detailed section, or portion thereof, that forms a basis for generating the machine-readable code). Further details of example embodiments of operation 820 are provided below with respect to FIG. 9-10.

In operation 830, the document module 230 provides the version 600 of the document 400. As noted above, the version 600 includes the summary section 411 and replaces a first portion of the detailed section 412 with the code 612. Also, the version 600 includes the summary section 441 and replaces the detailed section 442 with the code 642. Moreover, the document module 230 may provide the version 600 in response to the request for provision of the document 400, as discussed above with respect to operation 810. In some example embodiments, the document module 230 generates the version 600 of the document 400 (e.g., prior to providing the version 600). Further details of example embodiments of operation 830 are discussed below with respect to FIG. 9-10.

As shown in FIG. 9, the method 800 may include one or more of operations 910, 920, 930, 932, 934, and 936. Operation 910 may be performed as part (e.g., a precursor task, a subroutine, or a portion) of operation 810, in which the access module 210 accesses the document 400. In operation 910, the access module 210 accesses metadata of the document 400. As noted above, the metadata may define the sections of summary information (e.g., summary sections 411 and 441) and the sections of detailed information (e.g., detailed sections 412 and 442) in the document 400.

Operation 920 may be performed as part of operation 820, in which the encoder module 220 generates the machine-readable code (e.g., based on the document 400), in operation 920, the encoder module 220 generates an image (e.g., an image file that defines an array of pixels) of the machine-readable code generated in operation 820. This generated image may be included in the version 600 of the document 400 (e.g., during generation of the version 600 in operation 830).

One or more of operations 930, 932, 934, and 936 may be performed as pan of operation 830, in which the document module 230 provides the document 400. In operation 930, the document module 230 generates the version 600 of the document 400 to include the image of the machine-readable code, as discussed above with respect to operation 920.

In operation 932, the document module 230 generates the version 600 of the document 400 to include fewer pages (e.g., only the pages 410, 420, and 430, compared to the pages 410-480) than the document 480 (e.g., in its original form, as accessed in operation 810).

In operation 934, the document module 230 generates a one-dimensional barcode from which at least a portion of the detailed section discussed above with respect to operation 810 is reproducible. For example, operation 934 may involve formatting (e.g., sizing, arranging, or adjusting aspect ratio) the image discussed above with respect to operation 920 as a one-dimensional barcode. This one-dimensional barcode may be included in the version 600 (e.g., as the code 612 or the code 642). As noted above, this one-dimensional barcode (e.g., in the form of the code 612 or the code 642) may represent at least the portion of the detailed section discussed above with respect to operation 810.

In operation 936, the document module 230 generates a two-dimensional barcode (e.g., a QR code) from which at least a portion of the detailed section discussed above with respect to operation 810 is reproducible. For example, operation 936 may involve formatting the image discussed above with respect to operation 920 as a two-dimensional barcode. This two-dimensional barcode may be included in the version 600 (e.g., as the code 612 or the code 642). As noted above, this two-dimensional barcode (e.g., in the form of the code 612 or the code. 642) may represent at least the portion of the detailed section discussed above with respect to operation 810.

As shown in FIG. 10, the method 800 may include one or more of operations 1020, 1021, 1022, 1023, 1024, 1026, 1028, 1030, 1032, 1034, and 1036. One or more of operations 1020-1024 may be performed as part of operation 820, in which the encoder module 220 generates the machine-readable code (e.g., code 612 or code 642).

In some example embodiments, the detailed information in the detailed section discussed with respect to operation 810 is formatted as tabular rows of CSVs. One or more of these tabular rows may be independently encoded, compressed, encrypted, or any suitable combination thereof, during the generation of the machine-readable code in operation 820.

In operation 1020, the encoder module 220 derives a tabular row of CSVs from at least a portion of the detailed section discussed above with respect to operation 810. In example embodiments that include operation 1020, operation 820 may be performed based on this tabular row of CSVs. For example, the encoder module 220 may generate the machine-readable code based on the tabular row of CSVs derived in operation 1020. In certain example embodiments, the encoder module 220 may derive a tabular row of CSVs from a first portion of the detailed section 412, and performance of operation 820 may generate the code 612 based on this first portion of the detailed section 412. In various example embodiments, the encoder module 220 may derive a tabular row of CSVs from the entirety of the detailed section 442, and performance of operation. 820 may generate the code 642 based on the entirety of the detailed section 442.

In operation 1021, the encoder module 220 compresses the tabular row of CSVs derived in operation 1020. According to various example embodiments, any one or more of several data compression algorithms (e.g., run length encoding) may be implemented, in whole or in part, to compress the tabular row.

In operation 1022, the encoder module 220 encrypts the tabular row of CSVs derived in operation 1020 (e.g., with or without data compression from performance of operation 1021). According to various example embodiments, ally one or more of several data encryption algorithms (e.g., symmetric encryption or asymmetric encryption) may be implemented, in whole or in part, to encrypt the tabular row. In example embodiments that include operation 1022, a decryption key that is usable to decrypt the encrypted tabular row may be generated in operation 1022 and stored (e.g., in the database 115) for providing later to an authorized user (e.g., user 152), so that the authorized user may operate his device (e.g., device 150) to scan the machine-readable code (e.g., code 612 or code 642) and use the decryption key to reproduce the tabular row of CSVs for viewing. Communication of such a decryption key is discussed below with respect to operation 1026.

In operation 1023, the encoder module 220 encodes a chunk (e.g., a portion) of the machine-readable code (e.g., code 612 or 642) by encoding the tabular row of CSVs derived in operation 1020. This tabular row may be encoded as a single chunk of the machine-readable code. Accordingly, multiple tabular rows of CSVs may be encoded as multiple chunks of the machine-readable code.

In operation 1024, the encoder module 220 compares the size of the chunk encoded in operation 1023 to a threshold chunk size (e.g., a maximum chunk size). Operation 1024 may include the encoder module 220 determining that the encoded chunk is smaller than the threshold chunk size. Accordingly, the encoded chunk may be accepted by the encoder module 220 for representation as a portion of the machine-readable code being generated in operation 820 and thus encoded within the machine-readable code. Alternatively, if the encoded chunk is larger than the threshold chunk size, the encoder module 220 may iteratively attempt to encode smaller and smaller chunks, until the size of the encoded chunk falls below the threshold chunk size.

In example embodiments that include operation 1022, in which the encoder module 220 encrypts the tabular row of CSVs, operation 1026 may be performed before or after operation 830, in which the document module 230 provides the version 600 of the document 400. In operation 1026, the encoder module 220 communicates a decryption key that is usable to decrypt the encrypted tabular row of CSVs. In some example embodiments, operation 1026 includes generating, storing, and communicating the decryption key. This may have the effect of allowing an authorized use (e.g., user 152) to scan the machine-readable code (e.g., code 612 or code 642) with his device (e.g., device 150) and use the communicated decryption key to reproduce the tabular row of CSVs for viewing (e.g., as part of reproducing the detailed section that contains the tabular row).

According to some example embodiments, a label (e.g., label 648) may be included in the version 600 of the document 400. As noted above, a label may be arranged adjacent to, or proximate to, the machine-readable code (e.g., code 642) generated in operation 820. Hence, operation 1028 may be performed after operation 820. In operation 1028, the encoder module 220 generates a label label 648) that describes at least the portion of the detailed section (e.g., detailed section 442) that formed a basis for generating the machine-readable code in operation 820. In example embodiments that include operation 1028, this generated label may be included in the version 600 of the document 400 (e.g., printed or communicated as part of the version 600). Causing the version 600 to be printed with the generated label is discussed below with respect to operation 1032.

One or more of operations 1030, 1032, 1034, and 1036 may be performed as part of operation 830, in which the document module 230 provides the version 600 of the document 400. In operation 1030, the document module 230 causes the version 600 of the document 400 be printed (e.g., onto paper or to a file) without the detailed section, or portion thereof, that formed the basis for generating the machine-readable code (e.g., code 612 or code 642) in operation 820. Instead, the document module 230 may cause the version 600 to be printed with that detailed section, or portion thereof, replaced by the machine-readable code generated in operation 820. For example, as noted above, the version 600 may include codes 612, 614, 642, 652, 654, and 656 (e.g., machine-readable codes), which may replace the detailed sections 412, 442, and 452 within the version 600.

In example embodiments that include operation 1028, operation 1032 may be performed to include the label generated in operation 1028 into the version 600 of the document 400. In operation 1032, the document module 230 causes the version 600 to be printed (e.g., onto paper or to a file) with the label (e.g., label 648). The label may be printed adjacent to, or otherwise proximate to, the machine-readable code (e.g., code 642) generated in operation 820.

In operation 1034, the document module 230 communicates the version 600 of the document 400. For example, the version 600 may be communicated from the document machine 110 to the device 130 (e.g., for printing or display by the device 130). In some example embodiments that include operation 1026, operation 1026 may be combined with operation 1034. According to various example embodiments, the document module 230 causes the version 600 of the document 400 be communicated (e.g., via the network 190) without the detailed section, or portion thereof, that formed the basis for generating the machine-readable code (e.g., code 612 or code 642) in operation 820. Instead, the document module 230 may cause the version 600 to be communicated with that detailed section, or portion thereof, replaced by the machine-readable code generated in operation 820. For example, as noted above, the version 600 may include codes 612, 614, 642, 652, 654, and 656 (e.g., machine-readable codes), which may replace the detailed sections 412, 442, and 452 within the version 600.

In operation 1036, the document module 230 provides the version 600 of the document 400 to a user of a device (e.g., user 152 of the device 150). The device may be configured to reproduce the detailed section, or portion thereof, that formed a basis for generating the machine-readable code (e.g., code 612 or code 642) in operation 820. For example, the device may be configured (e.g., by executing a software application, applet, or app) to scan the machine-readable code (e.g., using a camera or other optical scanner) and process the machine-readable code. This processing of the machine-readable code may include decoding the machine-readable code, decrypting one or more tabular rows of CSVs, decompressing one or more tabular rows of CSVs, formatting one or more tabular rows of CSVs, displaying one or more tabular rows of CSVs, or any suitable combination thereof. This may have the effect of enabling the user (e.g., user 152) to reproduce the detailed information contained in the detailed section, or portion thereof, for viewing.

According to various example embodiments, one or more of the methodologies described herein may facilitate clean and compact printing of a document (e.g., a business report). Moreover, one or more of these methodologies may facilitate priming or communication of the compacted version of the document. Furthermore, one or more of these methodologies may facilitate enhanced privacy by encryption and decryption of detailed information contained in the document. Hence, one or more the methodologies described herein may facilitate dissemination, concealment, reproduction, and presentation of detailed information that is summarized within the document.

When these effects are considered in aggregate, one or more of the methodologies described herein may obviate a need for certain efforts or resources that otherwise would be involved in the dissemination, concealment, reproduction, and presentation of such detailed information. Efforts expended by a user in performing such tasks may be reduced by one or more of the methodologies described herein. Computing resources used by one or more machines, databases, or devices (e.g., within the network environment 100) may similarly be reduced. Examples of such computing resources include processor cycles, network traffic, memory usage, data storage capacity, power consumption, and cooling capacity.

FIG. 11 is a block diagram illustrating components of a machine 1100, according to some example embodiments, able to read instructions from a machine-readable medium (e.g., a machine-readable storage medium) and perform any one or more of the methodologies discussed herein, in whole or in part. Specifically, FIG. 11 shows a diagrammatic representation of the machine 1100 in the example form of a computer system and within which instructions 1124 (e.g., software, a program, an application, an applet, an app, or other executable code) for causing the machine 1100 to perform any one or more of the methodologies discussed herein may be executed. In alternative, embodiments, the machine 1100 operates as a standalone device or may be connected (e.g., networked) to other machines. In a networked deployment, the machine 1100 may operate in the capacity of a server machine or a client machine in a server-client network environment, or as a peer machine in a peer-to-peer (or distributed) network environment. The machine 1100 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1124, sequentially or otherwise, that specify actions to be taken by that machine. Further, while only a single machine is illustrated, the term “machine” shall also be taken to include a collection of machines that individually or jointly execute the instructions 1124 to perform any one or more oldie methodologies discussed herein.

The machine 1100 includes a processor 1102 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1104, and a static memory 1106, which are configured to communicate with each other via a bus 1108. The machine 1100 may further include a graphics display 1110 (e.g., a plasma display panel (PDP), a light emitting diode (LED) display, a liquid crystal display (LCD), a projector, or a cathode ray tube (CRT)). The machine 1100 may also include an alphanumeric input, device 1112 (e.g., a keyboard), a cursor control device 1114 (e.g., a mouse, a touchpad, a trackball, a joystick, a motion sensor, or other pointing instrument), a storage unit 1116, a signal generation device 1118 (e.g., a speaker), and a network interface device 1120.

The storage unit 1116 includes a machine-readable medium 1122 on which is stored the instructions 1124 embodying any one or more of the methodologies or functions described herein. The instructions 1124 may also reside, completely or at least partially, within the main memory 1104, within the processor 1102 (e.g., within the processor's cache memory), or both, during execution thereof by the machine 1100. Accordingly, the main memory 1104 and the processor 1102 may be considered as machine-readable media. The instructions 1124 may be transmitted or received over a network 1126 (e.g., network 190) via the network interface device 1120.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1122 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., machine 1100), such that the instructions, when executed by one or more processors of the machine (e.g., processor 1102), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform, certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used, herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time access the memory device to retrieve and process the stored output. Hardware modules may also initiate communications with input or output devices, and can operate on a resource (e.g., a collection of information).

The various operations of example methods described herein may performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm.). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The following enumerated descriptions define various example embodiments of methods and systems (e.g., apparatus) discussed herein:

1. A method comprising:

accessing a document that includes a summary section that summarizes a detailed section of the document, the accessing of the document being in response to a request for provision of the document;
generating a machine-readable code based on at least a portion of the detailed section and from which at least the portion of the detailed section summarized by the summary section is reproducible, the generating of the machine-readable code being performed by a processor of a machine; and
providing a version of the document that includes the summary section of the document and replaces at least the portion of the detailed section of the document with the machine-readable code from which at least the portion of the detailed section is reproducible, the providing of the version of the document being responsive to the request for provision of the document.

2. The method of description 1, wherein:

the accessing of the document includes accessing metadata that defines the summary section of the document and defines the detailed section of the document.

3. The method of description 1 or description 2, wherein:

the generating of the machine-readable code includes generating an image of the machine-readable code; and
the providing of the version of the document includes generating the version of the document to include the image of the machine-readable code.

4. The method of any of descriptions 1-3, wherein:

the generating of the machine-readable code includes generating a one-dimensional barcode from which at least the portion of the detailed section of the document is reproducible.

5. The method of any of descriptions 1-3, wherein:

the generating of the machine-readable code includes generating a two-dimensional barcode from which at least the portion of the detailed section of the document is reproducible.

6. The method of description 5, wherein:

the generating of the two-dimensional barcode generates a quick response code (QR code) that represents at least the portion of the detailed section of the document.

7. The method of any of descriptions 1-6, wherein:

the generating of the machine-readable code from which the detailed section is reproducible includes deriving a tabular row of comma separated values (CSVs) from at least the portion of the detailed section of the document; and
the generating of the machine-readable code is based on the tabular row of CSVs derived from at least the portion of the detailed section of the document.

8. The method of description 7, wherein:

the generating of the machine-readable code includes compressing the tabular row of CSVs derived from at least the portion of the detailed section.

9. The method of description 7 or description 8, wherein:

the generating of the machine-readable code includes encrypting the tabular row of CSVs derived from at least the portion of the detailed section; and the method further comprises communicating a decryption key usable to decrypt the encrypted tabular row of CSVs derived from at least the portion of the detailed section.

10. The method of any of descriptions 7-9, wherein:

the generating of the machine-readable code includes encoding, a chunk of the machine-readable code by encoding the tabular row of CSVs derived from at least the portion of the detailed section.

11. The method of description 10, wherein:

the generating of the machine-readable code includes determining that the encoded tabular row of CSVs is smaller than a threshold chunk size.

12. The method of any of descriptions 1-11 further comprising:

generating a label that describes at least the portion of the detailed section reproducible from the machine-readable code; and wherein the providing of the version of the document includes causing the version of the document to be printed with the label that describes at least the portion of the detailed section reproducible from the machine-readable code.

13. The method of any of descriptions 1-12, wherein:

the detailed section of the document spans more pages in the document than the generated machine-readable code; and
the providing of the version of the document includes generating the version of the document with fewer pages than the document.

14. The method of any of descriptions 1-13, wherein:

the providing of the version of the document includes causing the version of the document to be printed with at least the portion of the detailed section replaced by the machine-readable code from which at least the portion of the detailed section is reproducible.

15. The method of any of descriptions 1-14, wherein:

the providing of the version of the document includes communicating the version of the document with at least the portion of the detailed section replaced by the machine-readable code from which at least the portion of the detailed section is reproducible.

16. The method of any of descriptions 1-15, wherein:

the providing of the version of the document is to a user of a device configured to reproduce at least the portion of the detailed section from the machine-readable code provided in the version of the document.

17. The method of any of descriptions 1-16, wherein:

the generating of the machine-readable code generates the machine-readable code from which at least the portion of the detailed section is reproducible without loss of information included in the portion.

18. A non-transitory machine-readable storage medium comprising instructions that, when executed by one or more processors of a machine, cause the machine to perform operations comprising:

accessing a document that includes a summary section that summarizes a detailed section of the document, the accessing of the document being in response to a request for provision of the document;
generating a machine-readable code based on at least a portion of the detailed section and from which at least the portion of the detailed section summarized by the summary section is reproducible, the generating of the machine-readable code being performed by the one or more processors of the machine; and
providing a version of the document that includes the summary section of the document and replaces at least the portion of the detailed section of the document with the machine-readable code from which at least the portion of the detailed section is reproducible, the providing of the version of the document being responsive to the request for provision of the document.

19. The non-transitory machine-readable storage medium of description 18, wherein:

the generating of the machine-readable code from which the detailed section is reproducible includes deriving a tabular row of comma separated values (CSVs) from at least the portion of the detailed section of the document; and
the generating of the machine-readable code is based on the tabular row of CSVs derived from at least the portion of the detailed section of the document.

20. A system comprising:

an access module configured to access a document that includes a summary section that summarizes a detailed section of the document, the accessing of the document being in response to a request for provision of the document;
a processor configured by an encoder module to generate a machine-readable code based on at least a portion of the detailed section and from which at least the portion of the detailed section summarized by the summary section is reproducible; and
a document module configured to provide a version of the document that includes the summary section of the document and replaces at least the portion of the detailed section of the document with the machine-readable code from which at least the portion of the detailed section is reproducible, the providing of the version of the document being responsive to the request for provision of the document.

21. The system of description 20, wherein:

the processor is configured by the encoder module to generate the machine-readable code by generating a two-dimensional barcode from which at least the portion of the detailed section of the document is reproducible.

22. The system of description 20 or description 21, wherein:

the processor is configured by the encoder module to derive a tabular row of comma separated values (CSVs) from at least the portion of the detailed section of the document; and
the encoder module configures the processor to generate the machine-readable code based on the tabular row of CSVs derived from at least the portion of the detailed section of the document.

What is claimed is:

1. A method comprising:
accessing a document that includes a first section that summarizes a second section of the document, the accessing of the document being in response to a request for provision of the document;
generating a machine-readable code based on at least a portion of the second section and from which at least the portion of the second section summarized by the first section is reproducible,
the generating of the machine-readable code being performed by a processor of a machine; and
providing a version of the document that includes the first section of the document and replaces at least the portion of the second section of the document with the machine-readable code from which at least the portion of the second section is reproducible,
the providing of the version of the document being responsive to the request for provision of the document.

2. The method of claim 1, wherein:
the accessing of the document includes accessing metadata that defines the first section of the document and defines the second section of the document.

3. The method of claim 1, wherein;
the generating of the machine-readable code includes generating an image of the machine-readable code; and
the providing of the version of the document includes generating the version of the document to include the image of the machine-readable code.

4. The method of claim 1, wherein:
the generating of the machine-readable code includes generating a one-dimensional barcode from which at least the portion of the second section of the document is reproducible.

5. The method of claim 1, wherein:
the generating of the machine-readable code includes generating a two-dimensional barcode from which at least the portion of the second section of the document is reproducible.

6. The method of claim 5, wherein:
the generating of the two-dimensional barcode generates a quick response code (QR code) that represents at least the portion of the second section of the document.

7. The method of claim 1, wherein:
the generating of the machine-readable code from which the second section is reproducible includes deriving a tabular row of comma separated values (CSVs) from at least the portion of the second section of the document; and
the generating of the machine-readable code is based on the tabular row of CSVs derived from at least the portion, of the second section of the document.

8. The method of claim 7, wherein:
the generating of the machine-readable code includes compressing the tabular row of CSVs derived from at least the portion of the second section.

9. The method of claim 7, wherein:
the generating of the machine-readable code includes encrypting the tabular row of CSVs derived from at least the portion of the second section; and the method further comprises
communicating a decryption key usable to decrypt the encrypted tabular row of CSVs derived from at least the portion of the second section.

10. The method of claim 7, wherein:
the generating of the machine-readable code includes encoding a chunk of the machine-readable code by encoding the tabular row of CSVs derived from at least the portion of the second section.

11. The method of claim 10, wherein:
the generating of the machine-readable code includes determining that the encoded tabular row of CSVs is smaller than a threshold chunk size.

12. The method of claim 1 further comprising:
generating a label that describes at least the portion of the second section reproducible from the machine-readable code; and wherein
the providing of the version of the document includes causing the version of the document to be printed with the label that describes at least the portion of the second section reproducible from the machine-readable code.

13. The method of claim 1, wherein:
the second section of the document spans more pages in the document than the generated machine-readable code; and
the providing of the version of the document includes generating the version of the document with fewer pages than the document.

14. The method of claim 1, wherein:
the providing of the version of the document includes causing the version of the document to be printed with at least the portion of the second section replaced by the machine-readable code from which at least the portion of the second section is reproducible.

15. The method of claim 1, wherein:
the providing of the version of the document includes communicating the version of the document with at least the portion of the second section replaced by the machine-readable code from which at least the portion of the second section is reproducible.

16. The method of claim 1, wherein:
the providing of the version of the document is to a user of a de ice configured to reproduce at least the portion of the second section from the machine-readable code provided in the version of the document.

17. The method of claim 1, wherein:
the generating of the machine-readable code generates the machine-readable code from which at least the portion of the second section is reproducible without loss of information included in the portion.

18. A non-transitory machine-readable storage medium comprising instructions that, when executed by one or more processors of a machine, cause the machine to perform operations comprising:
accessing a document that includes a first section that summarizes a second section of the document, the accessing of the document being in response to a request for provision of the document;
generating a machine-readable code based on at least a portion of the second section and from which at least the portion of the second section summarized by the first section is reproducible,
the generating of the machine-readable code being performed by the one or more processors of the machine; and
providing a version of the document that includes the first section of the document and replaces at least the portion of the second section of the document with the machine-readable code from which at least the portion of the second section is reproducible,
the providing of the version of the document being responsive to the request for provision of the document.

19. The non-transitory machine-readable storage medium of claim 18, wherein:
the generating of the machine-readable code from which the second section is reproducible includes deriving a tabular row of comma separated values (CSVs) from at least the portion of the second section of the document; and
the generating of the machine-readable code is based on the tabular row of CSVs derived from at least the portion of the second section of the document.

20. A system comprising:
an access module configured to access a document that includes a first section that summarizes a second section of the document, the accessing of the document being in response to a request for provision of the document;
a processor configured by an encoder module to generate a machine-readable code based on at least a portion of the second section and from which at least the portion of the second section summarized by the summary section is reproducible; and
a document module configured to provide a version of the document that includes the first section of the document and replaces at least the portion of the second section of the document with the machine-readable code from which at least the portion of the second section is reproducible,
the providing of the version of the document being responsive to the request for provision of the document.

21. The system of claim 20, wherein:
the processor is configured by the encoder module to generate the machine-readable code by generating a two-dimensional barcode from which at least the portion of the second, section of the document is reproducible.

22. The system of claim 20, wherein:
the processor is configured by the encoder module to derive a tabular row of comma separated values (CSVs) from at least the portion of the second section of the document; and
the encoder module configures the processor to generate the machine-readable code based on the tabular row of CSVs derived from at least the portion of the second section of the document.
